(19) United States
(12) Patent Application Publication
(10) Pub. No.: US 2008/0271836 A1
(43) Pub. Date: Nov. 6, 2008

(54) Device for Embossed Foil Printing

(75) Inventors: Franz-Peter Richter, Frankisch-Crumbach (DE); Jurgen Scholzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN ROLAND DRUCKMASCHINEN AG, Offenbach (DE)

(21) Appl. No.: 11/578,645

(22) PCT Filed: Apr. 6, 2005
(86) PCT No.: PCT/EP05/03587

§ 371 Date: Jan. 5, 2007

(30) Foreign Application Priority Data
Apr. 13, 2004 (DE) 10 2004 018 306.6
Apr. 13, 2004 (DE) 10 2004 018 320.1
Apr. 29, 2004 (DE) 10 2004 021 102.7
Feb. 26, 2005 (DE) 10 2005 008 940.2

(51) Int. Cl. B41F 19/06

(52) U.S. Cl. 156/233

(57) ABSTRACT

For transferring a coating in the form of a desired image coating from a backing film to a printed sheet, an adhesive layer in the form of the desired image is applied to the printed sheet. The transfer foil comprising the image-type coating is rolled over the printed sheet using contact pressure in a coating unit (2), in such a way that the coating adheres to the adhesive sections, thus forming an image. To improve the flexibility of this application in a printing press, either the coating unit or the adhesive application unit (1) and the coating unit (2) are located in one or more coating modules of a printing press, thus producing a simple, compact film transfer module (F).

### FIELD OF THE INVENTION

The invention pertains to a device for transferring image-forming layers from a carrier foil to printing sheets.

### BACKGROUND OF THE INVENTION

Producing metallic layers on sheets through a foil transfer method is known. For example, EP 0 569 520 B1 discloses a printing material and a printing device that utilizes this foil material. This reference relates to a sheet-fed machine with a feed unit and a delivery unit. Printing units and a coating module are arranged between the feed and delivery units. An adhesive pattern is applied by lithographic printing in at least one of the printing units. This adhesive pattern is applied with a cold printing method and has a certain design. A foil guide provided in the coating module is arranged downstream of the printing unit and features an impression cylinder and a press cylinder. This foil guide is designed such that a foil strip or transfer foil can be guided from a foil supply roll through a transfer gap of the coating module between the impression cylinder and the press cylinder. The foil strip is rewound on the delivery side after it emerges from the coating module. The transfer foil features a carrier layer on which image-forming layers such as metallic layers (for example, aluminum) may be applied. A separation layer is provided between the metallic layer and the carrier foil. The separation layer ensures that the metallic layer can be removed from the carrier layer.

Each sheet is provided with an adhesive pattern as the sheets are transported through the printing unit. Subsequently, the sheet is guided through the coating module, in which the sheet lying on the impression cylinder is brought in contact with the foil material via the press cylinder. During this process, the metallic layer is arranged on the bottom and is tightly bonded to the areas of the sheet that were provided with the adhesive. After the sheet is transported further, the metallic layer only adheres in the area of the adhesive pattern. This means that the metallic layer is removed from the carrier foil only in the area of the adhesive pattern. The used transfer foil is then rewound and the sheet is delivered in the coated state.

Utilizing coating modules of this type, for example, in printing units of printing machines is known. However, using coating or printing units in this manner means that the corresponding printing units are unavailable for use in image printing. In addition, retrofitting these printing units is relatively complicated.

### BRIEF SUMMARY OF THE INVENTION

In view of the foregoing, an object of the invention is providing a device that allows a printing machine to be flexibly utilized when it is used for embossed foil printing. Advantageously, the transfer foil is brought in contact with the printing substrate using an impression cylinder and a press cylinder in at least one coating module. The coating module preferably is arranged downstream of one or more printing units of a printing machine.

The coating unit can be arranged at any location within the sheet-fed printing machine. In a printing machine with several printing units, the image-forming coating or metallic layers can be applied before, after as well as in between the application of printing ink layers. For this purpose, the coating unit can be in the form of a portable coating module.

The inventive device also allows several coating units to be arranged one after another within a sheet-fed machine. Consequently, the application of different image-forming coatings or metallic layers within a particular design can be carried out in succession. In this respect, a first pattern of adhesive can be applied with a first image-forming coating in a first coating module and another pattern of adhesive that includes the first pattern of adhesive can then be applied with the second pattern of adhesive being provided with another image-forming coating.

### BRIEF DESCRIPTION OF THE SEVERAL VIEWS OF THE DRAWING(S)

FIG. 1 is a schematic side view of an exemplary foil transfer module according to the invention associated with an impression cylinder.

FIG. 2 is a schematic side view of a second exemplary embodiment of a foil transfer module according to the invention associated with an impression cylinder.

FIG. 3 is a schematic side view of an illustrative printing machine utilizing a foil transfer module according to the invention.

FIG. 4 is a schematic side view of another embodiment of a printing machine utilizing a foil transfer module according to the invention.

FIG. 5 is a schematic side view of the printing machine of FIG. 3 with the foil transfer module modified to tangentially guide the foil.

FIG. 6 is a schematic side view of the printing machine of FIG. 4 with the foil transfer module modified to tangentially guide the foil.

### DETAILED DESCRIPTION OF THE INVENTION

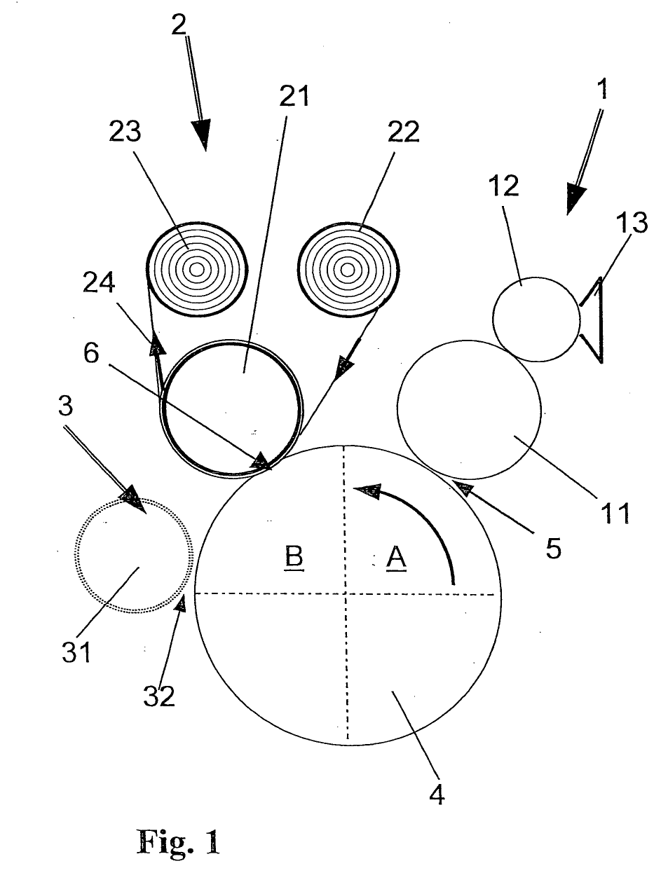

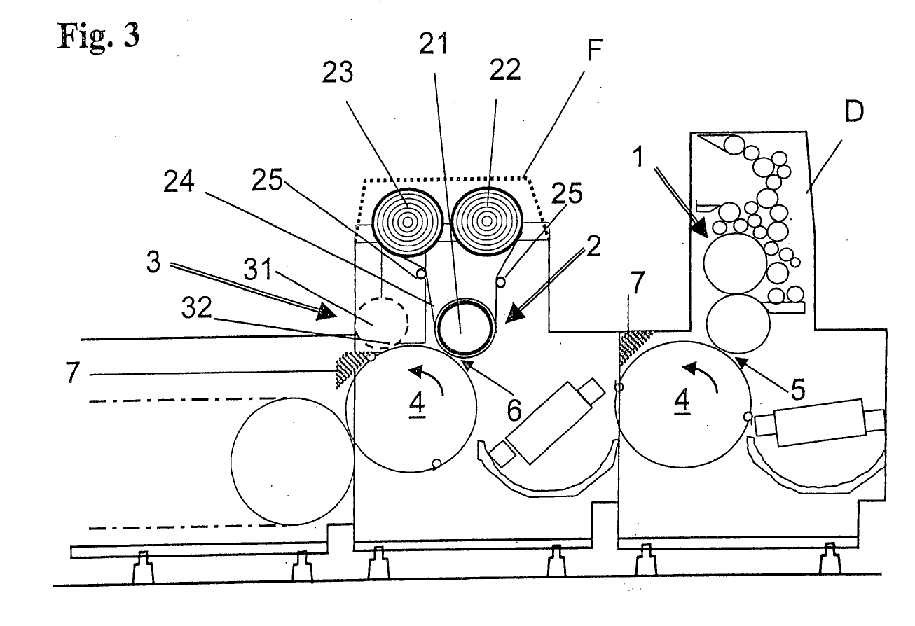

Referring to FIG. 1 of the drawings an integrated foil transfer module (referenced as F in FIGS. 3-6) for foil transfer in a sheet-fed machine, for example, a printing machine is shown. The illustrated foil transfer module is configured as described below.

The foil transfer module includes a sheet-guiding impression cylinder 4 for transporting sheets. In order to transport the sheets, the impression cylinder 4 can have one or more gripper sections with associated printing faces. Thus, the impression cylinder can have a single or a multiple circumference.

An application unit 1 is associated with the impression cylinder 4 in quadrant A. The application unit 1 features a plate cylinder 11, an application roller 12 and a metering system 13. Coating patterns can be applied on the sheet being held on the impression cylinder 4 in the application unit 1 via the plate cylinder 11. A coating unit 2 is associated with the impression cylinder 4 in quadrant B. The coating unit 2 can be configured for foil transfer printing and features a press cylinder 21 together with the impression cylinder 4 defines a transfer gap 6. In addition, a foil supply roll 22, a foil collecting roll 23 and, if applicable, foil strip guides are provided. In this case, the transfer foil comprises a foil strip 24 guided around the press cylinder 21. The cylinders can correspond to the plate cylinder and the impression cylinder of a coating module of an offset printing machine. In addition, a calendaring unit 3 can be arranged downstream of the impression cylinder 4 relative to the rotational direction of the coating unit 2. The calendaring unit 3 defines a calendaring gap 32 between a calendar roller 31 and the impression cylinder 4.

The arrangement of FIG. 1 provides an integrated foil transfer module that features two work stations which can be used as follows. First, a sheet to be coated is provided with an image-forming adhesive pattern using a form in the first workstation (application unit 1). Specifically, the adhesive pattern is applied in a nip 5 between the plate cylinder 21 and the impression cylinder 4. In the next workstation (coating unit 2), the sheet is subsequently guided through a transfer gap 6 between a cylinder in the form of a press cylinder 21 and the impression cylinder 4 together with the foil strip 24. In the transfer gap 6, the transfer foil is pressed against the sheet. This pressure causes an image-forming layer to be transferred from the transfer foil to the sheet in the area of the adhesive pattern. The foil strip 24 is unrolled from the foil supply roll 22 in the direction of the rotational movement of the impression cylinder 4, looped around the press cylinder 21 and rewound on the foil collecting roll 23. The image-forming layer transferred from the transfer foil to the sheet can be rolled over in the calendaring gap 32 of the downstream calendaring unit 3 in order to improve its adhesion and luster.

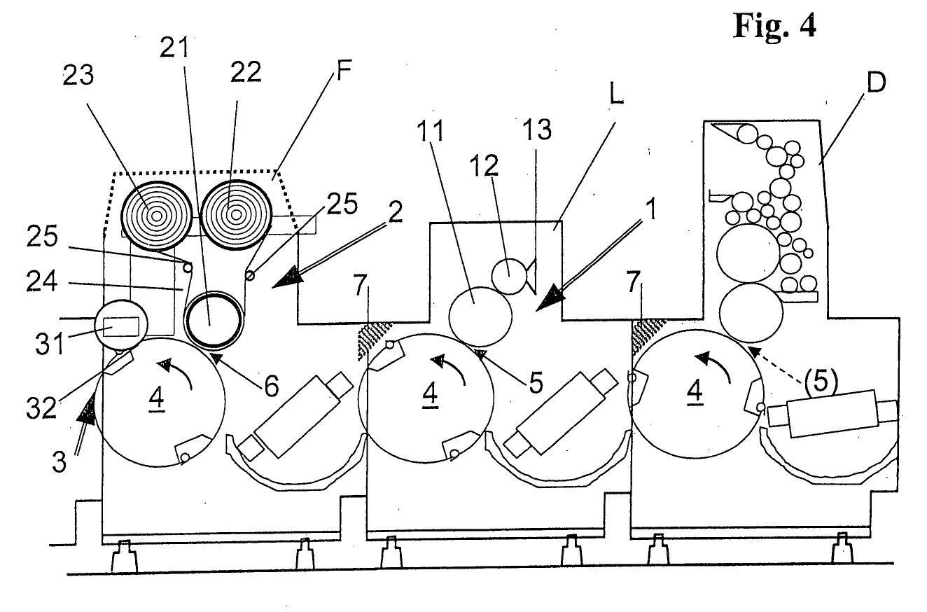

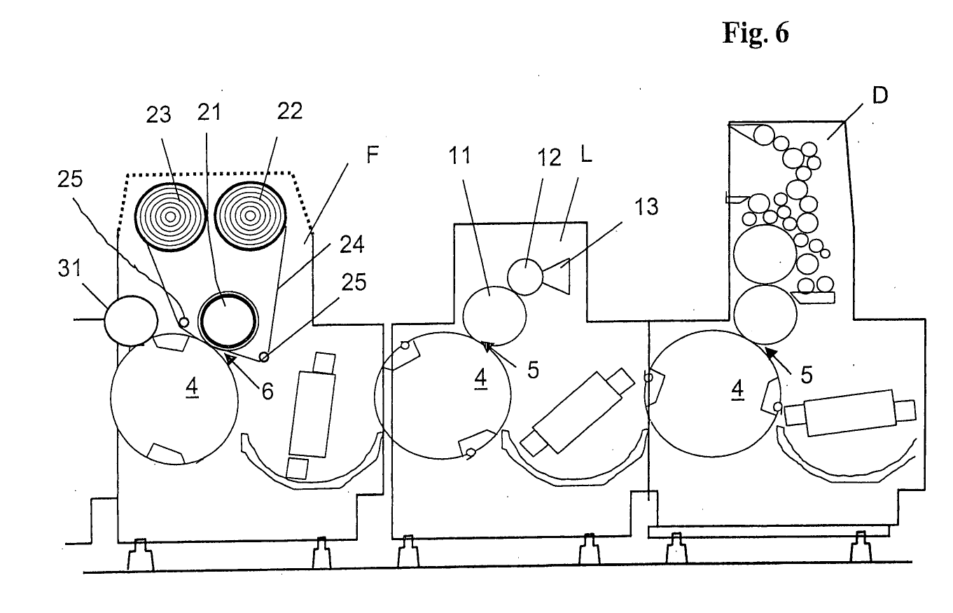

The described foil transfer module can be used in a varnishing module of a sheet-fed printing machine. The basic version of such a varnishing module (referenced as L in FIGS. 4 and 6) features a sheet-guiding impression cylinder 4, a plate cylinder 11 and an application roller 12, e.g., an anilox roller, and a metering system 13 (e.g., a doctor blade system). In such an application, the doctor blade system is not used for supplying varnish, but rather for metering the adhesive to be applied on the substrate with the anilox roller or application roller and the plate cylinder via, for example, a recessed rubber blanket or a flexographic form.

In terms of its basic concept, the structure of the varnishing module corresponds to that of a printing unit of a printing machine that features a plate cylinder 11 instead of the plate and offset blanket cylinder. In addition, the varnishing module does not include an inking unit with a multitude of rollers or a dampening unit. Consequently, the varnishing module has empty space available above the coating devices. Accordingly, the required foil guiding elements can be easily integrated into the varnishing module L in a user-friendly and compact manner that is also cost-efficient. In such a foil transfer module, the substrate also can be guided through all the necessary required gap locations with just a single gripper closing with the substrate lying on only one impression cylinder 4.

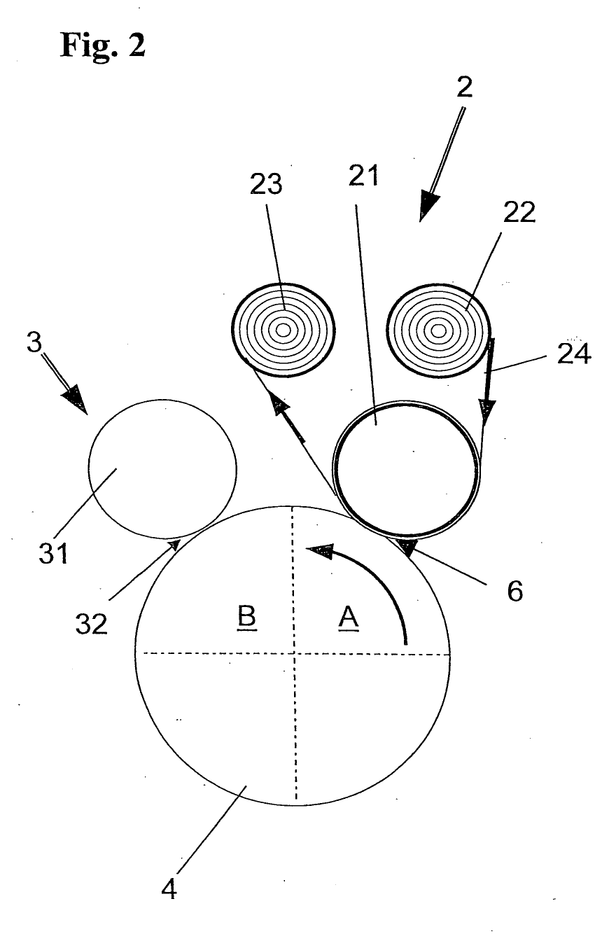

A second embodiment of an integrated foil transfer module for foil transfer in a sheet-fed machine, for example, a printing machine is illustrated in FIG. 2. The foil transfer module of FIG. 2 is configured as follows.

A sheet-guiding impression cylinder 4 is provided for transporting sheets. In order to transport the sheets, the impression cylinder 4 can have one or more gripper sections with associated printing faces. Thus, the impression cylinder can have a single or a multiple circumference. A coating unit 2 is associated with the impression cylinder 4 in quadrant A. The coating unit 2 is configured for foil transfer printing and features a press cylinder 21 that together with the impression cylinder 4 defines a transfer gap 6. In addition, a foil supply roll 22, a foil collecting roll 23 and, if applicable, foil strip guides for the foil strip 24 looped around the press cylinder 21 are also provided. The press cylinder 21 can correspond to the plate cylinder and the impression cylinder 4 can correspond to the impression cylinder of a coating module, e.g., a varnishing module of an offset printing machine. A calendaring unit 3 is associated with the impression cylinder 4 in quadrant B. The calendaring unit 3 is arranged downstream of the impression cylinder relative to the rotational direction of the coating unit 2. The calendaring unit 3 defines a nip 32 via a calendar roller 31 that cooperates with the impression cylinder 4.

The arrangement of FIG. 2 provides an integrated foil transfer module that features two work stations which can be used as follows. First, a sheet to be coated is provided with an image-forming adhesive pattern using a form in a separate work station arranged upstream of the foil transfer module. The adhesive pattern can be produced in a coating module (e.g., via a relief or flexographic printing method) or in an offset printing unit (via a lithographic printing method). In the first workstation (coating unit 2), the sheet is then guided through a transfer gap 6 between the press cylinder 21 and the impression cylinder 4 together with the foil strip 24 that is looped around the press cylinder 21. The pressure in the transfer gap causes an image-forming layer to be transferred from the transfer foil to the sheet in the area of the adhesive pattern. The foil strip 24 is unrolled from the foil supply roll 22 and rewound on the foil collecting roll 23. In another work station, the image-forming layer transferred from the transfer foil to the sheet can subsequently be rolled over in the nip 32 of the downstream calendaring unit 3 in order to improve its adhesion and luster.

As shown in FIGS. 3 and 4, the foil transfer module of the present invention can be used in sheet-fed printing machines. In particular, a printing unit D (see FIG. 3) or a varnishing module L (see FIG. 4) can be arranged directly upstream (relative to the sheet transport direction) of the foil transfer module F that serves as a coating unit 2 for foil transfer. The printing machine can be configured as a so-called dual varnishing machine (see FIG. 4).

In the embodiment of a sheet-fed machine shown in FIG. 3, a printing unit D (e.g., an offset printing unit) can be arranged directly upstream of the foil transfer module F. The printing unit D serves as the application unit 1 and features a lithographic form on a plate cylinder, a rubber blanket cylinder and an impression cylinder 4. The application of the adhesive is carried out in a conventional manner via offset printing with a lithographic form carrying the desired coating pattern. The adhesive is applied in a nip 5 of the printing unit D.

Alternatively, with relief printing methods, the plate cylinder can be separated from the offset blanket cylinder during application of the adhesive in the printing unit D. In such case, the offset blanket cylinder respectively carries a recessed offset blanket or a flexographic form. An application roller with a metering system, preferably an anilox roller with a doctor blade system, is assigned to the offset blanket cylinder (e.g., at the installation site of a rubber blanket washing device). In order to apply the adhesive, the application roller can be screwed up and down relative to the offset blanket cylinder.

In the modified embodiment according to FIG. 4, a varnishing module L is arranged directly upstream of the foil transfer module F. A printing unit D, in turn, can be arranged directly upstream of the varnishing module. A recessed rubber blanket or a flexographic form is fixed on the plate cylinder 11 of the varnishing module L. In the FIG. 4 embodiment, the varnishing module serves as an application unit 1 for the adhesive. A metering system 13 comprising a doctor blade system serves for metering the adhesive applied on the substrate via an anilox or application roller 13 and the plate cylinder 11. The substrate with the adhesive applied thereon is then delivered to the downstream coating module in the form of the foil transfer module F.

If a varnishing module L is retrofitted into a foil transfer module F, the anilox roller and the doctor blade system are removed. The plate cylinder serves as the press cylinder 21 for the transfer foil. In such case, at least the foil supply roll 22 for fresh transfer foil and the foil collecting roll 23 for used transfer foil are assigned to the plate cylinder. The press cylinder 21 transfers the image-forming layer from the transfer foil to the substrate, which is fixed on the impression cylinder 4 via the closed grippers, in the transfer gap 6. If required, a calendar roller 31 (in this case a calendaring unit 3) is arranged on the impression cylinder 4 downstream of the press cylinder 21 relative to the transport direction. In special applications, e.g., when a very absorbent substrate is used and the adhesive quickly penetrates into the substrate, a first layer of adhesive can be applied as a sort of base coat in a printing unit D arranged upstream of the varnishing module L as a base coat of sorts.

In the embodiments of to FIGS. 3 and 4, one or more UV dryers 7 can be provided so as to allow the utilization of an adhesive that can be dried by application of UV radiation. The UV dryers 7 can be assigned to an impression cylinder 4 downstream of a nip 5 or downstream of the transfer gap 6. The adhesive can also be dried in the area of the sheet delivery unit. With this embodiment of the foil transfer module F, the substrate can be guided through all of the required gap locations while it lies on only one impression cylinder 4 and with only a single gripper closing.

The transfer foil can be composed of multiple layers. The carrier layer of the transfer foil preferably consists of a thin and tear-resistant foil. An image-forming layer is applied on the carrier foil via a separation layer. The separation layer serves simplifies the removal of the image-forming layer from the carrier layer. For example, the image-forming layer can consist of a metallic layer, a gloss layer, a textured layer, a colored layer or a layer containing an image pattern.

The transfer foil can be used in so-called embossed foil printing. In embossed foil printing, an image-forming adhesive pattern is applied on a sheet. The adhesive pattern can be applied using a simple offset printing method. The coated side of the transfer foil is then placed on the sheet and pressed against the sheet such that the image-forming layers of the transfer foil are lifted off the transfer foil and adhere to the sheet in the form of a corresponding image pattern.

In the embossed foil printing devices according to the present invention, the foil supply roll 22 is assigned to the coating unit 2 on the side of the sheet feed unit and includes a rotary drive. The rotary drive helps feed the unused foil strip 24 to the coating unit 2 in a continuous and controlled manner. Therefore, the rotary drive is preferably a controllable drive. The used foil strip 24 is rolled up on a foil collecting roll 23 on the delivery side of the coating unit 2. In order to optimize production, a controllable drive can be provided for the foil collecting roll as well. In addition, tensioning rollers 25 may be provided in the area where the foil is being guided. The tensioning rollers 25 are arranged adjacent to the press cylinder 21 on both the side from which the foil strip 24 is feed to the transfer gap 6 and the side from which the foil strip 24 is delivered from the transfer gap 6. These tensioning rollers 25 enable the tension of the foil strip 24 relative to the press cylinder 21 to remain constant.

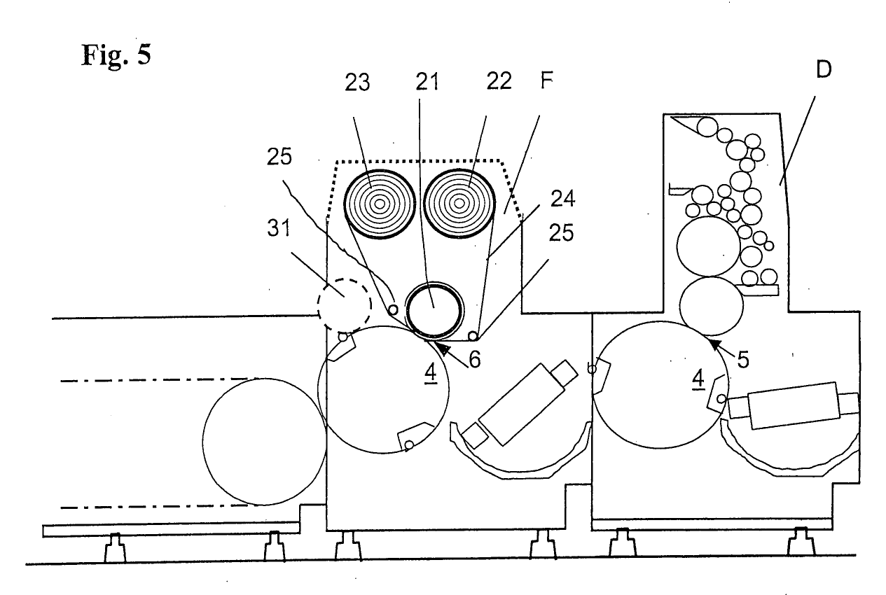

A special foil guide arrangement is illustrated in the embodiment shown in FIGS. 5 and 6. In this embodiment, the tensioning rollers 25 are arranged adjacent to the press cylinder 21. However, the tensioning rollers 25 are preferably arranged in the vicinity of the transfer gap 6 in such a way that the foil strip 24 is guided to the transfer gap 6 approximately tangential to the surface of the press cylinder 21. This tangential guidance of the foil strip 24 reduces the friction between the foil strip 24 and the press cylinder 21 because the contact surface between the foil strip 24 and the surface of the press cylinder 21 is largely minimized. This can be advantageous if the foil strip 24 is transported in the transport direction in a cyclic fashion, for example, cycling with respect to the channel passage (press cylinder 21) or with respect to the design.

When the foil strip 24 is transported cyclically, the foil strip is preferably always stopped when no coating process should be carried out or when the channels of the cylinders cooperating in the transfer gap 6 pass in such a manner that the transfer effect between the cylinder surfaces is interrupted. In such a case, a relative movement between the foil strip 24 and the surface of the press cylinder 21 inevitably takes place.

According to another embodiment of the invention, several foil strips 24 can be arranged in axially parallel relation to one another over a desired format width. Such an arrangement would include several foil supply rolls 22 and foil collecting roll 23. These foil supply rolls 22 and foil collecting rolls 23 can be selectively operated in a cyclic fashion collectively or in individual pairs for each of the foil strips 24.

The cyclic transport of the foil strip 24 is preferably achieved by coupling the driven foil supply rolls 22 and foil collecting rolls 23 to a machine control. For cyclic operation, a known foil reservoir in the form of a foil loop is provided. For example, the foil loop can be achieved by looping the foil strip around a compensating roller.

The surface of the press cylinder 21 is provided with a plastic coating comparable to a rubber blanket or an offset blanket. The plastic coating has a defined elasticity. In addition, the surface of the plastic coating is very smooth and only has insignificant adhesion relative to the transfer foil. The plastic surface enables a clean transfer of the image-forming layer to the sheet. The elasticity of the plastic coating also results in a comparatively wide nip. The transfer gap 6 can be additionally increased, for example, with an impression cylinder 4 that has twice the diameter of the press cylinder 21. All these measures make it possible to provide a wide pressing surface in the transfer gap 6 and to ensure a relative movement between the surface of the press cylinder 21 pressing against the transfer foil and the impression cylinder 4. These measures can also ensure the transfer of very fine patterns from the image-forming layer to the sheet.

If desired, in addition to the above-described device characteristics, an additional processing unit, e.g., for embossing, cutting or punching, a varnishing unit for the surface finishing of the substrates or an imprinting unit can be arranged downstream of the foil transfer module. For example, after the transfer foil is transferred to the substrate and the subsequent pressing and smoothing are completed, an imprint or print of conventional offset printing ink or, alternatively, so-called UV ink and/or a varnishing of the image-forming coating of the transfer foil (e.g., UV varnishing in connection with excimer drying) can be produced on the foil situated on the substrate. For this purpose, at least one additional printing unit and/or at least one varnishing unit can be arranged downstream of the foil transfer module. For example, the luster can be further increased if the image-forming coating of the transfer foil is subjected to additional varnishing.

The invention may be realized in the form of the illustrated embodiments, but is not restricted to the concrete characteristics of these embodiments.

### LIST OF REFERENCE SYMBOLS

1 Application unit
2 Coating unit
3 Calendaring unit
4 Impression cylinder
5 Nip
6 Transfer gap
7 UV dryer
11 Plate cylinder
12 Application roller
13 Metering system
21 Press cylinder
22 Foil supply roll
23 Foil collecting roll
24 Foil strip
25 Tensioning roller
31 Calendar roller
32 Calendaring gap
A Quadrant
B Quadrant
F Foil transfer module
D Printing unit
L Varnishing module

1-17. (canceled)

18. A device for a sheet-processing machine for transferring an image-forming layer from a transfer foil to a printing sheet comprising:
an application unit for coating an image area of the printing sheet with an adhesive pattern;
a coating unit for transferring the image-forming layer from the transfer foil to the printing sheet, the coating module including an impression cylinder and a press cylinder, the transfer foil being guidable around the press cylinder in such a way that the image-forming layer of the transfer foil adheres to the image area of the printing sheet and is separated from the transfer foil;
wherein the coating unit is part of a foil transfer module positionable directly downstream of a printing unit of the sheet-processing machine.

19. The device according to claim 18 wherein the foil transfer module includes a foil supply roll for fresh transfer foil and a foil collecting roll for used transfer foil which are assigned to the press cylinder within the foil transfer.

20. The device according to claim 18 wherein the foil transfer module comprises a varnishing module including an application roller and a metering system that are removable relative to a plate cylinder, the plate cylinder being convertible to the press cylinder via application of a smooth, compressible press covering.

21. The device according to claim 20 wherein the press covering comprises a surface element that covers part of the cylindrical surface area of the press cylinder.

22. The device according to claim 20 wherein the press covering includes a partial pressing surface having an outline corresponding to a region to be coated that is detachably mountable on the press cylinder.

23. The device according to claim 18 wherein the coating unit can be positioned at any location within the sheet-processing machine.

24. The device according to claim 18 wherein the sheet-processing machine consists of a printing press having a plurality of printing units.

25. The device according to claim 18 wherein the foil transfer module is portable.

26. The device according to claim 18 wherein the coating unit is one of a plurality of coating units arranged one after the other in the sheet-processing machine.

27. The device according to claim 18 wherein the printing unit comprises the application unit.

28. The device according to claim 18 wherein the application unit is in the form of a varnishing module that is arranged directly upstream of the coating unit.

29. The device according to claim 18 wherein the printing unit comprises the application unit and further including a second application unit in the form of a varnishing module arranged directly upstream of the coating unit.

30. The device according to claim 19 wherein the press cylinder has assigned guide elements for guiding the transfer foil.

31. The device according to claim 30 wherein the guide elements are arranged such that the transfer foil is guided in an approximately tangential manner relative to the surface of the transfer cylinder.

32. The device according to claim 31 wherein the guide elements include tensioning rollers.

33. The device according to claim 32 wherein the transfer foil can be transported in a transport direction in a cyclic fashion.

34. The device according to claim 18 wherein the foil transfer module comprises a coating module of the sheet-processing machine and the press cylinder corresponds to a plate cylinder of said coating module.

35. A device for a sheet-processing machine for transferring an image-forming layer from a transfer foil to a printing sheet comprising:
an application unit for coating an image area of the printing sheet with an adhesive pattern;
a coating unit for transferring the image-forming layer from the transfer foil to the printing sheet, the coating module including an impression cylinder and a press cylinder that define a transfer gap therebetween, the transfer foil being guidable through the transfer gap together with the printing sheet with a coated side of the transfer foil including the image-forming layer in contact with the printing sheet such that the image-forming layer adheres to the image area of the printing sheet and is separated from the transfer foil;
wherein the coating unit is part of a foil transfer module positionable directly downstream of a varnishing unit of the sheet-processing machine.

36. The device according to claim 35 wherein the foil transfer module includes a foil supply roll for fresh transfer foil and a foil collecting roll for used transfer foil which are assigned to the press cylinder within the foil transfer.

37. The device according to claim 35 wherein the foil transfer module comprises a second varnishing module including an application roller and a metering system that are removable relative to a plate cylinder, the plate cylinder being convertible to the press cylinder via application of a smooth, compressible press covering.

38. The device according to claim 37 wherein the press covering comprises a surface element that covers part of the cylindrical surface area of the press cylinder.

39. The device according to claim 37 wherein the press covering includes a partial pressing surface having an outline corresponding to a region to be coated that is detachably mountable on the press cylinder.

40. The device according to claim 35 wherein the coating unit can be positioned at any location within the sheet-processing machine.

41. The device according to claim 35 wherein the sheet-processing machine consists of a printing press having a plurality of printing units.

42. The device according to claim 35 wherein the foil transfer module is portable.

43. The device according to claim 35 wherein the coating unit is one of a plurality of coating units arranged one after the other in the sheet-processing machine.

44. The device according to claim 35 wherein the varnishing module comprises the application unit.

45. The device according to claim 35 wherein the varnishing module comprises the application unit and further including a second application unit in the form of a printing unit of the sheet-processing machine.

46. The device according to claim 36 wherein the press cylinder has assigned guide elements for guiding the transfer foil to the transfer gap.

47. The device according to claim 46 wherein the guide elements are arranged such that the transfer foil is guided to the transfer gap in an approximately tangential manner relative to the surface of the transfer cylinder.

48. The device according to claim 47 wherein the guide elements include tensioning rollers.

49. The device according to claim 48 wherein the transfer foil can be transported in a transport direction in a cyclic fashion.

50. The device according to claim 35 wherein the foil transfer module comprises a coating module of the sheet-processing machine and the press cylinder corresponds to a plate cylinder of said coating module.
